(19) United States
(12) Patent Application Publication
(10) Pub. No.: US 2013/0096858 A1
(43) Pub. Date: Apr. 18, 2013

(54) SYSTEM, METHOD, AND PROGRAM FOR PREDICTING STATE OF BATTERY

(71) Applicant: International Business Machines Corporation, Armonk, NY (US)

(72) Inventors: Masami Amano, Kanagawa-ken (JP); Tsuyoshi Ide, Kanagawa-ken (JP); Takayuki Osogami, Kanagawa-ken (JP); Toshihiro Takahashi, Kanagawa-ken (JP)

(73) Assignee: International Business Machines Corporation, Armonk, NY (US)

(21) Appl. No.: 13/652,663

(22) Filed: Oct. 16, 2012

(30) Foreign Application Priority Data
Oct. 17, 2011 (JP) 2011-228211

(51) Int. Cl. G06F 19/00; G06F 17/11

(52) U.S. Cl. 702/63

(57) ABSTRACT

A method and system for predicting degradation of a battery. Modeling of a battery is made to be separated into an aging section and a current-carrying section. The modeling is established such that the amount of degradation of a capacity retention ratio is determined by the linear sum of stay at each temperature and each SOC. The separation into degradation components at each temperature and each SOC enables predicting degradation under various degradation environments. A model for a battery separated into an aging section and a current-carrying section and a calculation model of a root law are combined into an objective function, and a table of discharge coefficients aₕ(T,S) and a table of current-carrying coefficients a_{c}(T,S) are generated using a solver, where T indicates the temperature and S indicates SOC. Once tables are generated, degradation of the battery can be predicted by calculation using the tables.

### CROSS-REFERENCE TO RELATED APPLICATION

This application claims priority under 35 U.S.C. §119 from Japanese Patent Application No. 2011-228211 filed Oct. 17, 2011, the entire contents of which are incorporated herein by reference.

### BACKGROUND OF THE INVENTION

1. Field of the Invention

The present invention relates to a system, method, and program for estimating the state of a secondary cell used in various electronic devices and motor-driven devices.

2. Description of Related Art

In recent years, transition toward a low-carbon society has been desired because of concerns about global warming and exhaustion of oil resources. As part the effort to advance the transition, the use of secondary cells in various industrial areas is becoming more important because that transition can be facilitated by power transaction using secondary cells in power grids, peak shifting using secondary cells in factories, and a change in the power system from an internal combustion engine using petroleum energy to an electric motor using electric power energy.

However, secondary cells suffer from the problem in which if they are repeatedly charged and discharged their charging ratio gradually decreases. Reduced performance in a secondary cell leads to reduction in the range of a vehicle that uses the secondary cell as the driving source and reduction in other running functions and raises a safety hazard. To address these issues, various techniques for estimating the state of a secondary cell have been proposed in the related art.

Japanese Unexamined Patent Application Publication No. 9-215207 discloses a technique for providing predictive information on a moment when a preset threshold of a battery discharge voltage is reached using a neural network in a system for monitoring a battery having a charging/discharging cycle.

Japanese Unexamined Patent Application Publication No. 11-32442 discloses a technique for estimating a remaining battery capacity. The technique converts charging and discharging voltage and current of a storage battery into digital signals using an ND converter and an A/D converter, respectively, to enable the voltage and current and a load, such as a motor, to be digitally processed.

Additionally, it converts the voltage and current into complex spectra using a frequency converter for voltage and a frequency converter for current, respectively, calculates an impedance using an impedance calculating unit from the obtained complex spectrum of the voltage V and that of the current I while the storage battery is used, determines a radius rj, which is the amount of features of the impedance, from the storage battery during operation, compares the radius rj with a radius ri, which has been previously determined and stored in a remaining battery capacity calculating unit, and estimates the remaining battery capacity from the mutual relationship obtained in the comparison.

Japanese Unexamined Patent Application Publication No. 2002-319438 discloses a technique for generating a state vector that describes the state of a battery, predicting a response for the state vector, measuring a response of the battery, and correcting the state vector based on the differences between the predicated response and the measured response to determine the state of the battery to successfully operate a hybrid powertrain and the like of a vehicle incorporating a battery pack and accurately estimate the charged state of the battery with good repeatability.

Japanese Unexamined Patent Application Publication No. 2011-38857 discloses a techniques that relates to a capacity retention ratio determination device capable of accurately determining a capacity retention ratio in a short period of time without fully charging or discharging a battery. The capacity retention ratio determination device includes an impedance measurement unit and a capacity estimation unit. The battery receives an alternating signal from a signal generator. The impedance measurement unit calculates frequency characteristics of AC impedance on the basis of a response signal from the battery in response to the alternating signal.

A feature frequency is determined from the calculated frequency characteristics. The capacity estimation unit includes a memory and a determination unit. The memory stores a correspondence relationship among a temperature of the battery, the feature frequency, and a capacity retention ratio. The determination unit determines the capacity retention ratio of the battery on the basis of the temperature of the battery detected by a temperature detector, the determined feature frequency, and the correspondence relationship stored in the memory.

The above-described known techniques disclose estimating the performance of a battery on the basis of the amount of features of impedance of the operating battery, the frequency characteristics of AC impedance measured on the basis of a response signal from the battery, the temperature of the battery, and the like, but does not disclose estimating the battery performance in consideration of a cell internal state or in consideration of a battery usage history.

Inaccuracy is a problem in terms of estimation of degradation of the battery.

Cells are used in various ways under actual operation of smart grids, factories, electric vehicles, and other applications. It is impossible to conduct in advance a degradation test on all of such usage patterns. Therefore, estimating degradation of a cell used in various ways by combining limited degradation tests is needed.

In many cases, it is necessary to monitor the state of a cell (capacity retention ratio, temperature, amount of electric conduction) under actual operation.

A root law model is known as a degradation model in, in particular, lithium-ion cells. However, in terms of assurance, such a root law is used mainly in a way in which a cell degradation test is conducted in advance in a certain period of time under the severest degradation environment for cells within a condition that is to be assured and the result is subjected to noise reduction or extrapolation using the root law.

Known techniques are unable to make predictions for various degradation environments and have difficulty in updating the model using a usage history under various degradation environments.

### SUMMARY OF THE INVENTION

In one aspect of the invention, a computer implemented processing method for predicting degradation of a battery is provided. The method includes the steps of preparing a table of variables for use in recording an aging degradation ratio at each of different states of charge (SOCs) and each of different temperatures, preparing a table of variables for use in recording a current-carrying degradation ratio at each of different SOCs and each of different temperatures, receiving data that contains a length of stay of the battery at each of different SOCs and each of different temperatures in a predetermined period, a current-carrying amount in the battery at each of different SOCs and each of different temperatures in the predetermined period, an initial capacity retention ratio in the predetermined period, and a last capacity retention ratio in the predetermined period, calculating a degradation speed coefficient by applying a computational expression of a given model for the battery to data on the initial capacity retention ratio in the predetermined period and on the last capacity retention ratio in the predetermined period and determining a linear sum model expression of a linear sum, a value of the aging degradation ratio, and a value of the current-carrying degradation ratio and storing the data in the tables, the linear sum being a sum of a value in which a product of each of the variables for use in recording the aging degradation ratio and each of the lengths of stay of the battery is added together at each of different SOCs and each of different temperatures and a value in which a product of each of the variables for use in recording the current-carrying degradation ratio and each of the current-carrying amounts in the battery is added together at each of different SOCs and each of different temperatures, the value of the aging degradation ratio and the value of the current-carrying degradation ratio being determined at each SOC and each temperature so as to reduce a difference between the degradation speed coefficients, where an arrangement of the aging degradation ratios and an arrangement of the current-carrying degradation ratios are usable in later prediction of the degradation of the battery.

In a second aspect of the invention, a computer readable storage medium tangibly embodying a computer readable program code having computer readable instructions which, when implemented, cause a computer to carry out the steps of a method for predicting degradation of a battery is provided. The method includes preparing a table of variables for use in recording an aging degradation ratio at each of different SOCs and each of different temperatures, preparing a table of variables for use in recording a current-carrying degradation ratio at each of different SOCs and each of different temperatures, receiving data that contains a length of stay of the battery at each of different SOCs and each of different temperatures in a predetermined period, a current-carrying amount in the battery at each of different SOCs and each of different temperatures in the predetermined period, an initial capacity retention ratio in the predetermined period, and a last capacity retention ratio in the predetermined period, calculating a degradation speed coefficient by applying a computational expression of a given model for the battery to data on the initial capacity retention ratio in the predetermined period and on the last capacity retention ratio in the predetermined period, and determining a linear sum model expression of a linear sum, a value of the aging degradation ratio, and a value of the current-carrying degradation ratio and storing the data in the tables, the linear sum being a sum of a value in which a product of each of the variables for use in recording the aging degradation ratio and each of the lengths of stay of the battery is added together at each of different SOCs and each of different temperatures and a value in which a product of each of the variables for use in recording the current-carrying degradation ratio and each of the current-carrying amounts in the battery is added together at each of different SOCs and each of different temperatures, the value of the aging degradation ratio and the value of the current-carrying degradation ratio being determined at each SOC and each temperature so as to reduce a difference between the degradation speed coefficients, where an arrangement of the aging degradation ratios and an arrangement of the current-carrying degradation ratios are usable in later prediction of the degradation of the battery.

In a third aspect of the invention, a computer implemented system for predicting degradation of a battery is provided. The system includes a storage unit, a table of variables for use in recording an aging degradation ratio at each of different SOCs and each of different temperatures and a table of variables for use in recording a current-carrying degradation ratio at each of different SOCs and each of different temperatures, the tables being prepared in the storage unit, a unit configured to store data that contains a length of stay of the battery at each of different SOCs and each of different temperatures in a predetermined period, a current-carrying amount in the battery at each of different SOCs and each of different temperatures in the predetermined period, an initial capacity retention ratio in the predetermined period, and a last capacity retention ratio in the predetermined period, a unit configured to calculate a degradation speed coefficient by applying a computational expression of a given model for the battery to data on the initial capacity retention ratio in the predetermined period and the last capacity retention ratio in the predetermined period, and a unit configured to determine a linear sum model expression of a linear sum, a value of the aging degradation ratio, and a value of the current-carrying degradation ratio and configured to store the data in the tables, the linear sum being a sum of a value in which a product of each of the variables for use in recording the aging degradation ratio and each of the lengths of stay of the battery is added together at each of different SOCs and each of different temperatures and a value in which a product of each of the variables for use in recording the current-carrying degradation ratio and each of the current-carrying amounts in the battery is added together at each of different SOCs and each of different temperatures, the value of the aging degradation ratio and the value of the current-carrying degradation ratio being determined at each SOC and each temperature so as to reduce a difference between the degradation speed coefficients, where an arrangement of the aging degradation ratios and an arrangement of the current-carrying degradation ratios are usable in later prediction of the degradation of the battery.

### BRIEF DESCRIPTION OF THE DRAWINGS

FIG. 1 is a diagram that illustrates a configuration for enacting an example of a scenario for carrying out the present invention.

FIG. 2 is a block diagram of hardware of a server in the scenario for carrying out the present invention.

FIG. 3 is a functional block diagram of the server for carrying out the present invention.

FIG. 4 illustrates a table of discharge coefficients.

FIG. 5 illustrates a table of current-carrying coefficients.

FIG. 6 illustrates a flowchart of calculation for the table of discharge coefficients and the table of current-carrying coefficients.

FIG. 7 illustrates a flowchart of calculation for prediction of degradation of a battery.

FIG. 8 is a block diagram that illustrates a battery and a configuration of an electronic control unit (ECU) therefor in a vehicle.

FIG. 9 is a block diagram of functions performed by the ECU relating to the battery in relation to the present invention.

### DETAILED DESCRIPTION OF THE PREFERRED EMBODIMENTS

Accordingly, it is an object of the present invention to provide a technique for predicting the state of a battery, the technique being capable of estimating it for various degradation environments and also capable of updating the model using a usage history under various degradation environments.

It is another object of the invention to provide a technique for predicting the state of a battery, the technique being capable of updating and refining the model using data about a cell history under actual running collected from a large number of commercially available electric vehicles.

A basic concept of the present invention is that modeling of a battery is made so as to be separated into an aging section and a current-carrying section. That is, the modeling is established such that the amount of degradation of a capacity retention ratio is determined by the linear sum of stay frequencies (current-carrying amounts during stay) at each temperature and each state of charge (SOC). The separation into degradation components at each temperature and each SOC enables predicting degradation under various degradation environments.

To this end, according to the present invention, where T indicates the temperature and S indicates SOC, tables of discharge coefficients aₕ(T,S) and current-carrying coefficients a_{c}(T,S) are prepared.

In another battery model, the capacity retention ratio y is described as y=f(z,t). Here, z indicates the degradation speed coefficient, and t indicates the time. In particular, it is known that, for a lithium-ion cell, the capacity retention ratio y can be represented by a root law model of the following equation.

y=−\sqrt{zt}+1 [Math. 1]

When this equation is differentiated with the time t and rearranged, z=2y′(y−1). Here, y indicates the mean of the capacity retention ratio at the time t and that at the time t+1, and y′ indicates the time derivative of y and indicates the degradation speed between the time t and the time t+1. The length of time between the time t and time t+1 may preferably be one week.

According to the modeling of the present invention, on the other hand, the equation of the model of the degradation speed coefficient can be given as follows.

$$\hat{z} = {\sum }_{T , S} Vh ( T , S ) {a}_{h} ( T , S ) + {\sum }_{T , S} Vc ( T , S ) {a}_{c} ( T , S ) \qquad [ Math . 2 ]$$

Here, Vh(T,S) indicates the length of stay in T,S between the time t and the time t+1, and Vc(T,S) indicates the current-carrying amount during the stay in T,S between the time t and the time t+1. y, y′, Vh(T,S), and Vc(T,S) are measured in advance and can be given as learning data.

An objective function using this model equation

$${argmin}_{{a}_{h} , {a}_{c}} {\vert z - \hat{z} \vert}^{2} \qquad [ Math . 3 ]$$

is solved under the constraints of

aₕ(T,S)≦aₕ(T+1,S)

a_{c}(T,S)≦a_{c}(T+1,S)

aₕ(T,S)≦aₕ(T,S+1).

This is a quadratic programming problem with linear constraints and thus can be solved using an existing solver.

When aₕ(T,S) and a_{c}(T,S) are determined in this way, providing Vh(T,S) and Vc(T,S) under an individual environment enables calculating a predictive value of the capacity retention ratio by, for example, using a root law model expression.

According to another aspect of the present invention, when the number of samples is small, aₕ(T,S) and a_{c}(T,S) can be calculated with an adjusted accuracy by solving an objective function in which an additional term is provided to the above-described objective function in consideration of the smoothing parameter λ and the values of elements adjacent to aₕ(T,S) and a_{c}(T,S).

As described above, the present invention can provide a technique for predicting degradation of a battery, the technique being capable of updating a model under various degradation environments using a usage history under various degradation environments.

The embodiments of the present invention will be described below with reference to the drawings. The same reference numerals indicate the same components through the drawings unless otherwise specified. It is to be noted that the embodiments of the present invention are merely illustrative examples of the present invention and are not intended to limit the present invention to the content described in the embodiments.

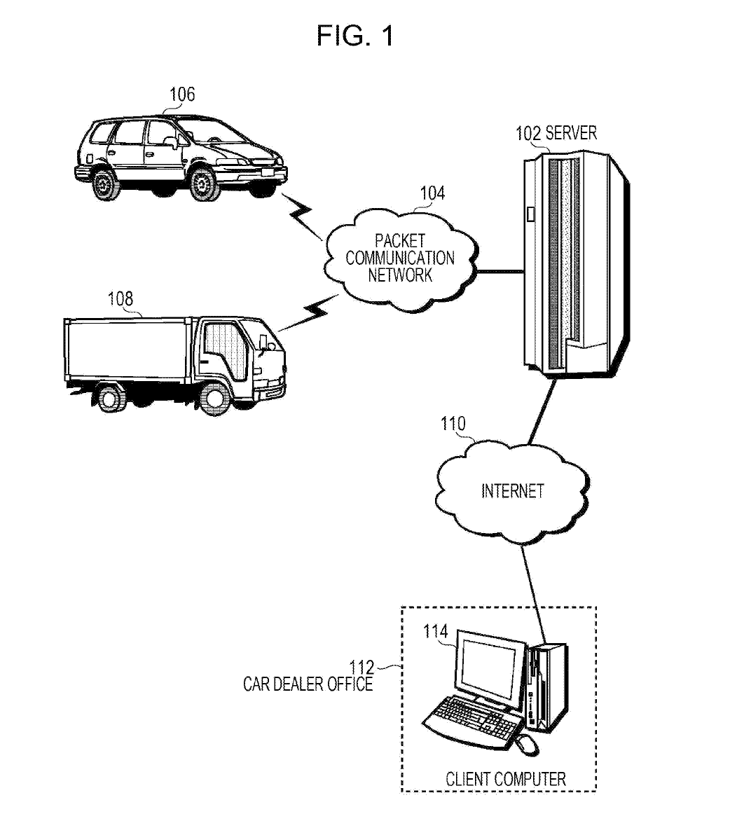

FIG. 1 is a diagram that illustrates an overall configuration of an example for carrying out the present invention. A server 102 constitutes a system in which information is collected from a plurality of vehicles 106 and 108 and other vehicles over a packet communication network 104, a so-called probe car communication system. Only two vehicles are illustrated in FIG. 1 for illustrative purposes, but many vehicles act as probe cars in actuality. Each of the vehicles 106 and 108 is an electric vehicle (EV) or a hybrid electric vehicle (HEV) incorporating a battery that is a secondary cell for driving. The probe car communication system is not limited to the above system and can be constructed using the technique disclosed in Japanese Unexamined Patent Application Publication No. 2005-4359, for example.

The server 102 is also connected to a client computer 114 in a car dealer office 112 over the Internet 110.

The server 102 has a battery degradation predicting system configured in accordance with the present invention. The details of the battery degradation predicting system are described later.

An exemplary scenario of the configuration illustrated in FIG. 1 is described below.
(1) The vehicles 106 and 108 and other vehicles, which are probe cars, transmit data about battery degradation environments (capacity retention ratio, SOC, temperature, load) to the server 102.
(2) When the number of data elements about degradation environments for a specific battery collected from the probe cars reaches a predetermined value, the server 102 calculates values in a table of discharge coefficients and a table of current-carrying coefficients for that battery and stores them in a non-volatile storage device, such as a hard disk.
(3) The server 102 estimates the battery life and calculates a recommended operation and charging schedule using the values in the table of discharge coefficients and the table of current-carrying coefficients for that battery, and transmits them to each of the probe cars.
(4) The server 102 transmits the estimation of the battery life of each of the probe cars to the client computer 114 in the car dealer office 112 for the probe cars. The dealer draws up a schedule of the time for replacing the battery by referring to the estimation of the battery life of each vehicle and provides appropriate after-sales service by, for example, informing the owner of the vehicle of the schedule.

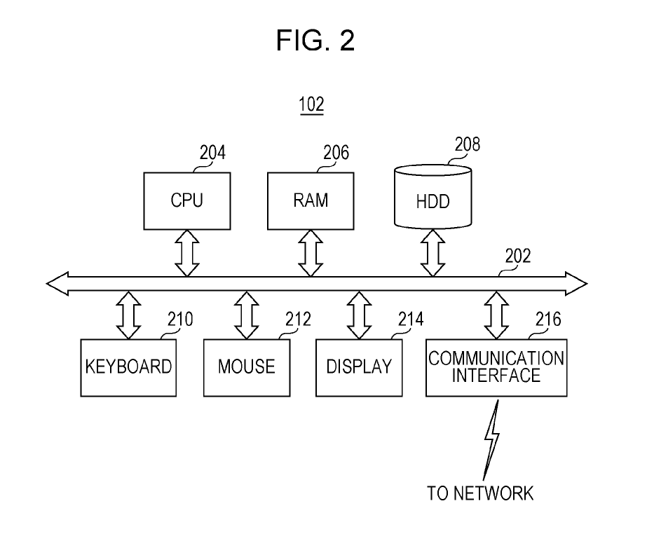

Next, an example hardware configuration of the server 102 is described with reference to the block diagram of FIG. 2. In FIG. 2, a system bus 202 is connected to a central processing unit (CPU) 204, a main memory (random-access memory (RAM)) 206, a hard disk drive (HDD) 208, a keyboard 210, a mouse 212, and a display 214. The CPU 204 may preferably be based on a 32-bit or 64-bit architecture. Examples of the CPU 204 can include Pentium® 4, Core® 2 Duo, and Xeon® of Intel Corporation and Athlon® of Advanced Micro Devices, Inc. The main memory 206 may preferably have a capacity of 4 GB or more. The hard disk drive 208 may preferably have a capacity of 500 GB or more, for example.

The hard disk drive 208 stores an operating system (not illustrated). The operating system can be any system compatible with the CPU 204. Examples of the operating system can include Linux®, Windows® 7 and Windows XP® of Microsoft Corporation, and Mac OS® of Apple Inc.

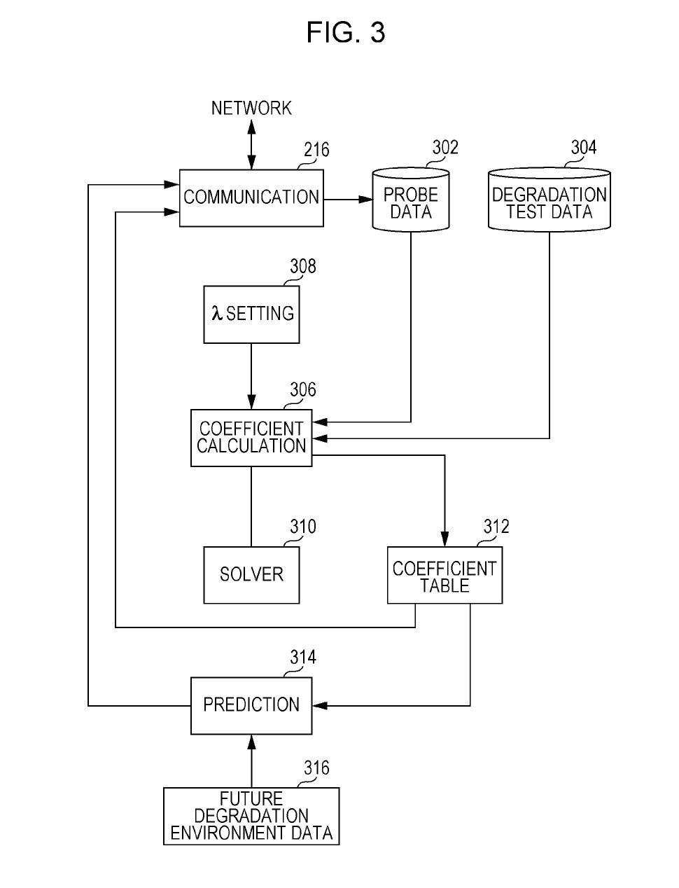

The hard disk drive 208 also stores probe data 302, degradation test data 304, a coefficient calculation routine 306, a smoothing parameter setting routine 308, a solver 310, a prediction routine 314, and future degradation environment data 316, which are described later with reference to FIG. 3. These routines can be generated by implementation of an existing programming language, such as C, C++, C#, or Java®. These modules can be loaded into the main memory 206 and executed by the action of the operating system as needed. The details of the operations of these modules are described later with reference to the functional block diagram of FIG. 3.

The keyboard 210 and the mouse 212 can be used by a user for operating a predetermined graphical user interface (GUI) screen (not illustrated), activating the smoothing parameter setting routine 308, and inputting a letter or a numeric character, for example.

The display 214 may preferably be a liquid crystal display and can be a display with any resolution. Examples of the display 214 can include XGA (1024×768 resolution) and UXGA (1600×1200 resolution). The display 214 can be used to display generated predictive data.

The system illustrated in FIG. 2 is also connected to an external network, such as a local area network (LAN) or a wide area network (WAN), through a communication interface 216 connected to the system bus 202. The communication interface 216 exchanges data with a system of, for example, a server, a client computer, or a probe car, on the external network by a mechanism, such as Ethernet®.

Next, an example functional configuration for performing processing of the present invention is described with reference to the block diagram of FIG. 3. The probe data 302 is a file that contains data collected from probe cars through the communication interface 216 and the network and that is stored in the hard disk drive 208. Measured data, including the capacity retention ratio of a battery, the length of stay at each temperature and each SOC, and the current-carrying amount at each temperature and each SOC, is stored in the probe data 302 for each battery type. In the probe cars, the capacity retention ratio can be measured using the technique described in Japanese Unexamined Patent Application Publication No. 2011-38857, for example, and the SOC can be measured using the technique described in Japanese Unexamined Patent Application Publication No. 2005-37230 or No. 2005-83970, for example.

The degradation test data 304 is a file that is different from the data collected from probe cars, that contains data measured by a performance degradation test for a battery conducted in advance, and that is stored in the hard disk drive 208. The file contains the data having the same form as that in the probe data 302.

The coefficient calculation routine 306 has the function of calculating values in the table of discharge coefficients aₕ(T,S) and the table of current-carrying coefficients a_{c}(T,S) at each temperature and each SOC by using the probe data 302 or the degradation test data 304 as needed. In particular, for the present embodiment, the smoothing parameter setting routine 308 for setting the smoothing parameter λ by an operation of a user is provided, and the smoothing parameter λ is set for the coefficient calculation routine 306. The smoothing parameter λ is used to maintain accuracy if the number of sample data elements collected from probe cars is small. The smoothing parameter λ can be adjusted by a user in accordance with the accuracy of a result of calculation, for example. If a certain number of sample data elements is collected, the sample data elements are separated into learning data and test data, a model is established using the learning data for various λ, the accuracy is determined using the test data, and λ at which the highest accuracy is obtained in the determination using the test data is adopted.

When the number of sample data elements sufficient, even if λ is zero, accuracy is obtainable. The coefficient calculation routine 306 calculates values of elements in the table of discharge coefficients aₕ(T,S) and the table of current-carrying coefficients a_{c}(T,S) at each temperature and each SOC by setting an objective function and a constraint using the probe data 302 or the degradation test data 304 and the smoothing parameter λ and causing the solver 310 to calculate the values. Examples of the solver 310 can include, but not limited to, IBM® ILOG® CPLEX. The details of calculation made by the solver 310 are described later.

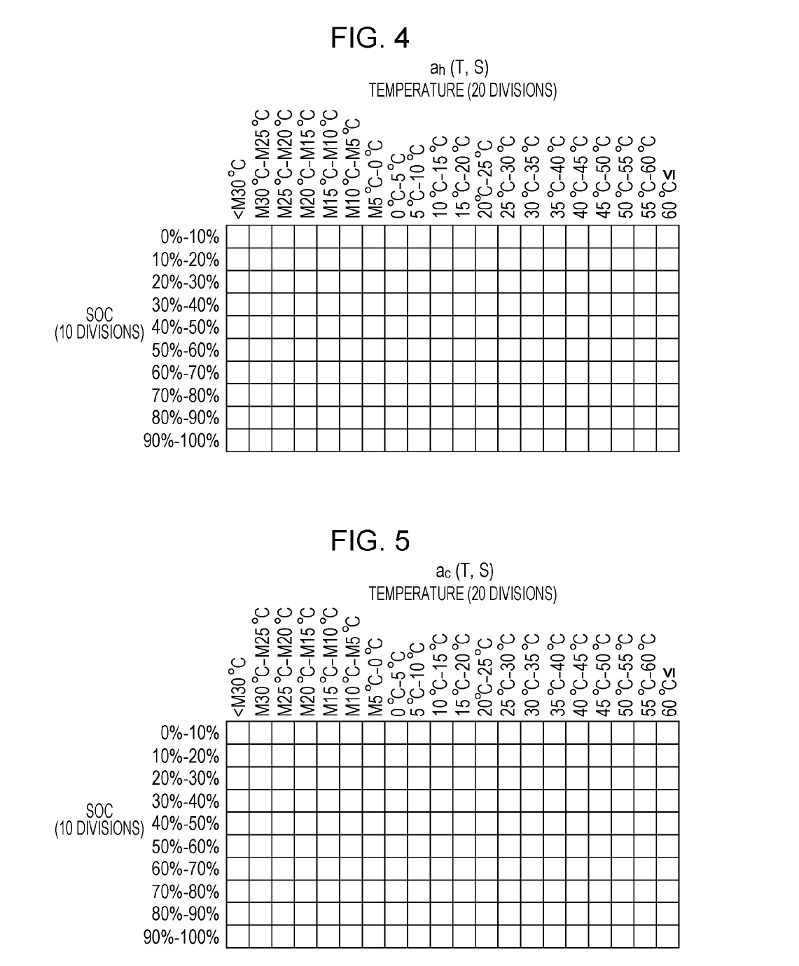

FIGS. 4 and 5 illustrate the elements in the table of aₕ(T,S) and the elements in the table of a_{c}(T,S), respectively, at each temperature and each SOC. As a result of calculation made by the coefficient calculation routine 306, a numerical value is set in each element. The table of discharge coefficients aₕ(T,S) and the table of current-carrying coefficients a_{c}(T,S) calculated in this way may preferably be stored as a coefficient table 312 in the hard disk drive 208.

The prediction routine 314 calculates a predictive value of the capacity retention ratio using the future degradation environment data 316 and the values in the coefficient table 312 calculated by the coefficient calculation routine 306. The details of the calculation made by the prediction routine 314 are described later.

The data in the coefficient table 312 and the predictive value calculated by the prediction routine 314 can be transmitted to a probe car, a car dealer, and other destinations through the communication interface 216 and the network as needed.

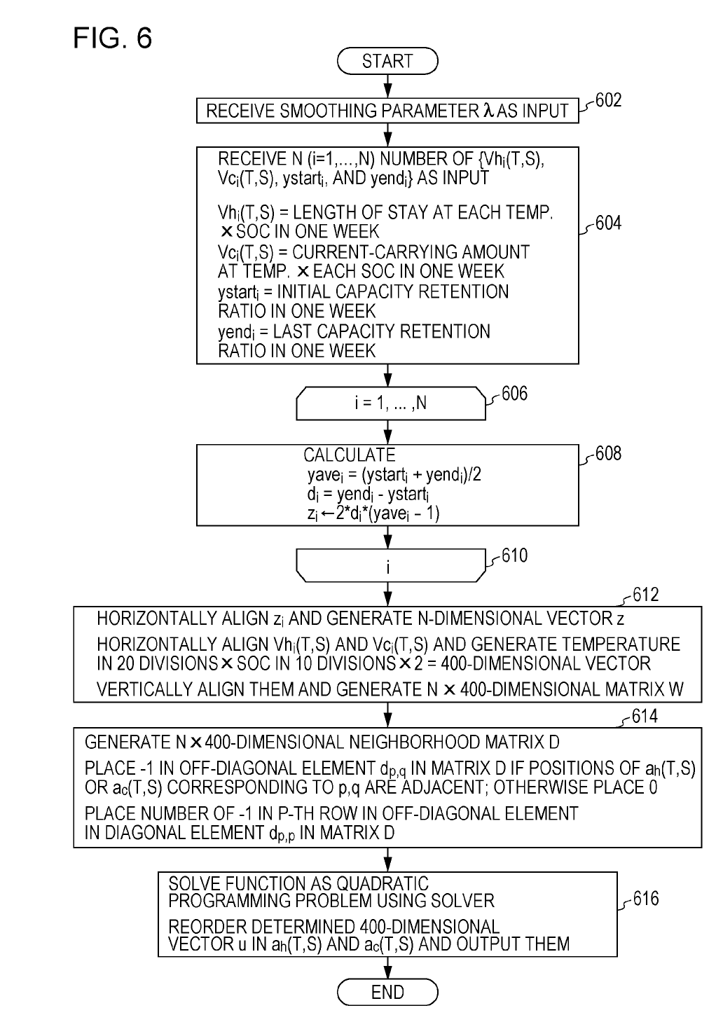

Next, processing performed by the coefficient calculation routine 306 is described with reference to the flowchart of FIG. 6. In FIG. 6, in step 602, the coefficient calculation routine 306 receives the smoothing parameter λ as an input from the smoothing parameter setting routine 308.

In step 604, the coefficient calculation routine 306 receives an N (i=1, . . . N) number of Vhᵢ (T,S), Vcᵢ (T,S), ystartᵢ, and yendᵢ as an input from the degradation test data 304 or the probe data 302.

Here, Vhᵢ(T,S) indicates an i-th length of stay at each temperature and each SOC in one week.

Vcᵢ(T,S) indicates an i-th current-carrying amount at each temperature and each SOC in the one week.

ystartᵢ indicates an i-th initial capacity retention ratio in the one week.

yendᵢ indicates an i-th last capacity retention ratio in the one week.

Here, one week is one example of a period of time and may be replaced with various periods, such as one day and one month, depending on the purpose.

Steps 606 through 610 are a loop from i=1 to N. In step 608, the coefficient calculation routine 306 makes calculation below.

yaveᵢ=(ystartᵢ+yendᵢ)/2

dᵢ=yendᵢ−ystartᵢ

zᵢ=2*dᵢ*(yaveᵢ−1)

When the processing of step 608 from i=1 to N ends, zᵢ(i=1, . . . N) is complete. In step 612, the coefficient calculation routine 306 horizontally aligns zᵢ(i=1, . . . N) and generates an N-dimensional vector z.

The coefficient calculation routine 306 horizontally aligns Vhᵢ(T,S) and Vcᵢ(T,S) to generate a 400-dimensional vector. More specifically, the coefficient calculation routine 306 generates the vector in the way described below. That is, in the present embodiment, because T has 20 divisions and S has 10 divisions, Vhᵢ(T,S) itself is in 200 dimensions. When S moves from 0 to 9 and T moves from 0 to 19 and the index j is used,

for Vhᵢ(T,S), j=S*20+T

for Vcᵢ(T,S), j=200+S*200+T.

In this way, for the index j=0, . . . , 399, Vhᵢ(T,S) and Vcᵢ(T,S) are arranged, and an i-th 400-dimensional vector is generated.

These vectors are vertically aligned from i=1 to N, a matrix with N rows and 400 columns is generated. This matrix is referred to as W.

Splitting T into 20 divisions and S into 10 divisions is merely one example. The width of a division and the interval between divisions may be various values, depending on the purpose.

In step 614, the coefficient calculation routine 306 generates a neighborhood matrix D with N rows and 400 columns in the following way.

That is, by the conversion rule of the index described above, each of p and q of the off-diagonal element d_{p,q} in the matrix D is made to be associated with the position of aₕ(T,S) or the position of a_{c}(T,S); when the positions are adjacent to each other, −1 is placed in the off-diagonal element d_{p,q} in the matrix D; otherwise 0 is placed. For the diagonal element d_{p,p} in the matrix D, the number of −1 in the p-th row is placed.

A supplementary explanation of the conversion rule of the index for p,q is provided. When 0≦p≦199, the quotient of p divided by 20 in association with aₕ(T,S) is S and the remainder of the division of p by 20 is T. When 200≦p≦399, the quotient of (p−200) divided by 20 in association with a_{c}(T,S) is S and the remainder of the division of (p−200) by 20 is T.

In step 616, the coefficient calculation routine 306 prepares a 400-dimensional vector u whose elements are real numbers, invokes the solver 310, and solves the following expressions. In the following expressions, Wu is a term that is represented by the linear sum of an aging degradation component and a current-carrying degradation component and that indicates the amount of degradation of the capacity retention ratio according to the present invention.

$${argmin}_{u} {\vert z - Wu \vert}^{2} + λ {u}^{T} Du \\ s . t . \\ {a}_{h} ( T , S ) \leq {a}_{h} ( T + 1 , S ) \\ {a}_{h} ( T , S ) \leq {a}_{h} ( T , S + 1 ) \\ {a}_{c} ( T , S ) \leq {a}_{c} ( T + 1 , S ) \qquad [ Math . 4 ]$$

Here, the constraints follow the conversion rule of the index described above and is entered as input in the solver 310.

For the element u[j] in the obtained 400-dimensional vector u, in the case where 0≦j≦199, when the quotient of j divided by 20 is S and the remainder of the division of j by 20 is T, aₕ(T,S)=u[j]; in the case where 200≦j≦399, when the quotient of (j−200) divided by 20 is S and the remainder of the division of (j−200) by 20 is T, a_{c}(T,S)=u[j].

As a result, the coefficient calculation routine 306 writes aₕ(T,S) and a_{c}(T,S) as the coefficient table 312 to the hard disk drive 208. In actuality, because the used degradation test data 304 or probe data 302 corresponds to a specific battery type, the coefficient table 312 stores aₕ(T,S) and a_{c}(T,S) for each battery type.

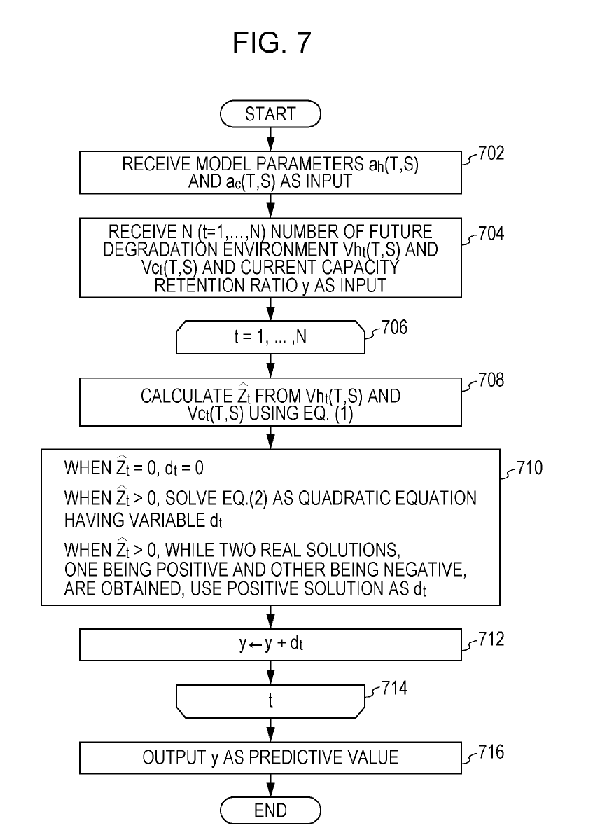

Next, processing performed by the prediction routine 314 is described with reference to the flowchart of FIG. 7.

In step 702, the prediction routine 314 receives the model parameters aₕ(T,S) and a_{c}(T,S) corresponding to the type of the used battery as an input from the coefficient table 312.

Then in step 704, the prediction routine 314 receives a N (t=1, . . . , N) number of future degradation environments Vhₜ(T,S) and Vcₜ(T,S) and a current capacity retention ratio y as an input. The N (t=1, . . . , N) number of future degradation environments Vhₜ(T,S) and Vcₜ(T,S) are received from the future degradation environment data 316. The future degradation environment data 316 is determined in advance from a future driving plan, driving practices, and other factors. For example, when a vehicle is used in commutation, a time series in the future degradation environment can be determined on the basis of the commuting distance on from Monday to Friday, a used plan on Saturday and Sunday, and other factors. The current capacity retention ratio y can be received from the probe data 302, for example.

Steps 706 through 714 are a loop from t=1 to N. The computational expressions used in this loop are represented as follows.

$$\begin{matrix}[ Math . 5 ] & \\ {\hat{z}}_{t} = {\sum }_{T , S} {Vh}_{t} ( T , S ) {a}_{h} ( T , S ) + {\sum }_{T , S} {Vc}_{t} ( T , S ) {a}_{c} ( T , S ) & ( 1 ) \\ {\hat{z}}_{t} = 2 {d}_{t} ( \frac{y + ( y + {d}_{t} )}{2} - 1 ) & ( 2 )\end{matrix}$$

In step 708, the prediction routine 314 calculates

\hat{z}ₜ [Math. 6]

from Vhₜ(T,S) and Vcₜ(T,S) using the above Equation (1).

In step 710, when

\hat{z}ₜ [Math. 7]

is zero, the prediction routine 314 determines dₜ=0.

In contrast, when

\hat{z}ₜ [Math. 8]

is larger than zero, the prediction routine 314 solves Equation (2) as a quadratic equation having the variable dₜ.

When

\hat{z}ₜ [Math. 9]

is larger than zero, two real solutions, one being positive and the other being negative, are obtained, and the positive real solution is adopted as dₜ.

In step 712, the prediction routine 314 updates y as y←y+dₜ.

When the loop from t=1 to N in steps 706 through 714 ends, the prediction routine 314 outputs y as a predictive value in step 716, and the processing is completed.

In the above-described embodiment, calculation for generating the table of discharge coefficients and the table of current-carrying coefficients and calculation for prediction using the table of discharge coefficients and the table of current-carrying coefficients are both made in a server. Alternatively, at least the calculation for prediction may be made in a car. An embodiment in this case is described below.

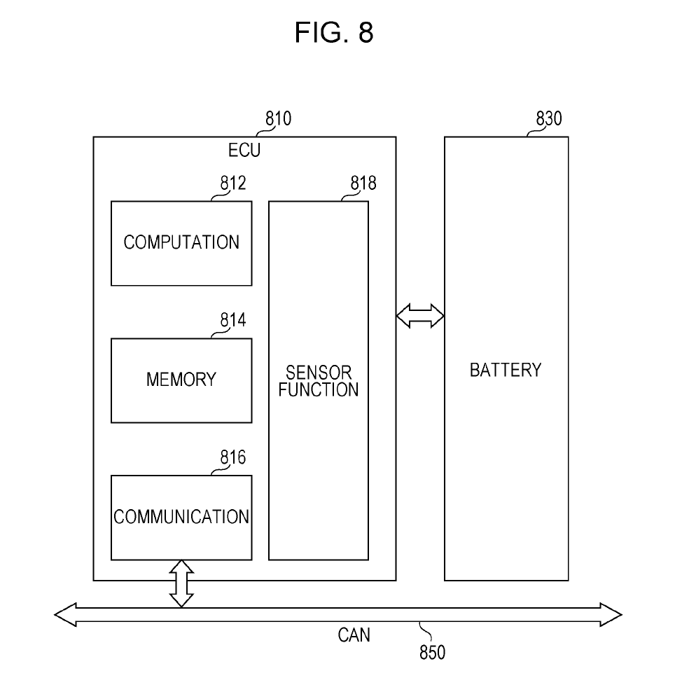

FIG. 8 is a block diagram of a hardware configuration in that embodiment. In particular, it is to be noted that FIG. 8 illustrates only sections relating to the present invention in a vehicle-mounted system.

FIG. 8 illustrates an electronic control unit (ECU) 810 used for a battery, a battery 830, and a vehicle-mounted network 850, such as a control area network (CAN).

The ECU 810 includes a computation unit 812 including a CPU, a memory 814 including a RAM and a non-volatile memory, such as a ROM or a flash memory, a communication unit 816 for exchanging information, such as a data frame, with the vehicle-mounted network 850, and a sensor function unit 818 for sensing the state of the battery 830.

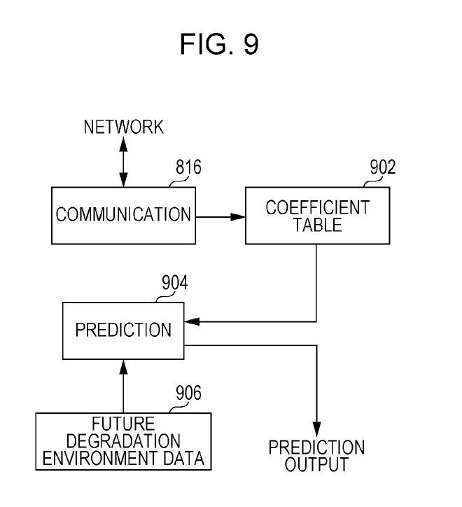

The non-volatile memory in the memory 814 stores a coefficient table 902, a prediction routine 904, future degradation environment data 906, and other elements, which are described later with reference to FIG. 9.

The battery 830 may preferably be a secondary cell usable in an electric vehicle or a hybrid car.

The sensor function unit 818 includes a device for measuring each of the voltage, current, temperature, insulation resistance, and other elements of the battery 830. The computation unit 812 has the function of performing the prediction routine 904, which is described later.

The memory 814 stores a program that controls the overall operation of the ECU 810 and that corresponds to the operating system.

Next, processing functions in the present embodiment are described with reference to the functional block diagram of FIG. 9. In FIG. 9, the coefficient table 902 has substantially the same form as in the coefficient table 312 illustrated in FIG. 3, the prediction routine 904 has substantially the same functions as in the prediction routine 314 illustrated in FIG. 3, and the future degradation environment data 906 has substantially the same form as in the future degradation environment data 316 illustrated in FIG. 3.

The coefficient table 902 in the functional block diagram of FIG. 9 is not obtained by calculation made in the ECU in an electric vehicle but is obtained by calculation made in the server as described above with reference to FIGS. 2 and 3. The coefficient table 902 is transmitted to the electric vehicle through the network and the communication unit 816 and set therein. This is because calculation for the coefficient table 902 typically employs the solver and that calculation is too heavy for the computing power of the ECU of an existing vehicle. If the computing power of the ECU is sufficiently high, the coefficient table 902 may be obtained by calculation locally made in the vehicle.

The data in the coefficient table 902 may not be received from the server using the communication function but may be written at the time of manufacture of the vehicle and rewritten to a value updated according to a large amount of probe data in the coefficient table by a person in charge of service at the time of maintenance, such as a regular inspection.

In the above embodiments, an example in which calculation is based on a root law well applicable to, in particular, a lithium-ion cell is described. More generally, in a degradation model in which y=f(z,t) and f is a monotone decreasing function with respect to t, it may be rearranged to z=g(y,t) and calculation may be brought to optimization by a solver.

The present invention is not limited to the above-described specific embodiments and can support various types of a secondary cell and modifications of a system configuration. A person skilled in the art will understand that the presence of an appropriate degradation model enables application to a lead-acid cell, a nickel-cadmium cell, a nickel metal hydride cell, a sodium-sulfur cell, a lithium-sulfur cell, a lithium-air cell, and a lithium-copper secondary cell and that the invention is not limited to a vehicle battery and is also applicable to a smart grid and various home appliances incorporating a secondary cell, such as a personal computer and a hand-held vacuum cleaner.

We claim:

1. A computer implemented processing method for predicting degradation of a battery, the method comprising the steps of:
preparing a table of variables for use in recording an aging degradation ratio at each of different states of charge (SOCs) and each of different temperatures;
preparing a table of variables for use in recording a current-carrying degradation ratio at each of different SOCs and each of different temperatures;
receiving data that contains a length of stay of the battery at each of different SOCs and each of different temperatures in a predetermined period, a current-carrying amount in the battery at each of different SOCs and each of different temperatures in the predetermined period, an initial capacity retention ratio in the predetermined period, and a last capacity retention ratio in the predetermined period;
calculating a degradation speed coefficient by applying a computational expression of a given model for the battery to data on the initial capacity retention ratio in the predetermined period and on the last capacity retention ratio in the predetermined period; and
determining a linear sum model expression of a linear sum, a value of the aging degradation ratio, and a value of the current-carrying degradation ratio and storing the data in the tables, the linear sum being a sum of a value in which a product of each of the variables for use in recording the aging degradation ratio and each of the lengths of stay of the battery is added together at each of different SOCs and each of different temperatures and a value in which a product of each of the variables for use in recording the current-carrying degradation ratio and each of the current-carrying amounts in the battery is added together at each of different SOCs and each of different temperatures, the value of the aging degradation ratio and the value of the current-carrying degradation ratio being determined at each SOC and each temperature so as to reduce a difference between the degradation speed coefficients, wherein an arrangement of the aging degradation ratios and an arrangement of the current-carrying degradation ratios are usable in later prediction of the degradation of the battery.

2. The processing method according to claim 1, wherein the battery is a lithium-ion battery and the computational expression for calculating the degradation speed coefficient is based on a root law model.

3. The processing method according to claim 1, wherein the step of determining the value of the aging degradation ratio and the value of the current-carrying degradation ratio at each SOC and each temperature is solved by a solver.

4. A battery degradation predicting method comprising the steps of:
the data in the tables generated by the processing method of claim 1;
reading data on a future degradation environment;
a step of calculating an amount of degradation of the capacity retention ratio by the linear sum model expression using the data in the tables and the data on the future degradation environment; and
determining a degradation predictive value by applying the calculated amount of degradation of the capacity retention ratio to the computational expression of the model.

5. A computer readable storage medium tangibly embodying a computer readable program code having computer readable instructions which, when implemented, cause a computer to carry out the steps of a method comprising:
preparing a table of variables for use in recording an aging degradation ratio at each of different SOCs and each of different temperatures;
preparing a table of variables for use in recording a current-carrying degradation ratio at each of different SOCs and each of different temperatures;
receiving data that contains a length of stay of the battery at each of different SOCs and each of different temperatures in a predetermined period, a current-carrying amount in the battery at each of different SOCs and each of different temperatures in the predetermined period, an initial capacity retention ratio in the predetermined period, and a last capacity retention ratio in the predetermined period;
calculating a degradation speed coefficient by applying a computational expression of a given model for the battery to data on the initial capacity retention ratio in the predetermined period and on the last capacity retention ratio in the predetermined period; and
determining a linear sum model expression of a linear sum, a value of the aging degradation ratio, and a value of the current-carrying degradation ratio and storing the data in the tables, the linear sum being a sum of a value in which a product of each of the variables for use in recording the aging degradation ratio and each of the lengths of stay of the battery is added together at each of different SOCs and each of different temperatures and a value in which a product of each of the variables for use in recording the current-carrying degradation ratio and each of the current-carrying amounts in the battery is added together at each of different SOCs and each of different temperatures, the value of the aging degradation ratio and the value of the current-carrying degradation ratio being determined at each SOC and each temperature so as to reduce a difference between the degradation speed coefficients, wherein an arrangement of the aging degradation ratios and an arrangement of the current-carrying degradation ratios are usable in later prediction of the degradation of the battery.

6. The computer readable storage according to claim 5, wherein the battery is a lithium-ion battery and the computational expression for calculating the degradation speed coefficient is based on a root law model.

7. The computer readable storage according to claim 5, wherein the step of determining the value of the aging degradation ratio and the value of the current-carrying degradation ratio at each SOC and each temperature is solved by a solver.

8. A battery degradation predicting program product comprising the program codes of:
reading the data in the tables generated by the computer readable storage of claim 5;
reading data on a future degradation environment;
calculating an amount of degradation of the capacity retention ratio by the linear sum model expression using the data in the tables and the data on the future degradation environment; and
determining a degradation predictive value by applying the calculated amount of degradation of the capacity retention ratio to the computational expression of the model.

9. A computer implemented system for predicting degradation of a battery, the system comprising:
a storage unit;
a table of variables for use in recording an aging degradation ratio at each of different SOCs and each of different temperatures and a table of variables for use in recording a current-carrying degradation ratio at each of different SOCs and each of different temperatures, the tables being prepared in the storage unit;
a unit configured to store data that contains a length of stay of the battery at each of different SOCs and each of different temperatures in a predetermined period, a current-carrying amount in the battery at each of different SOCs and each of different temperatures in the predetermined period, an initial capacity retention ratio in the predetermined period, and a last capacity retention ratio in the predetermined period;
a unit configured to calculate a degradation speed coefficient by applying a computational expression of a given model for the battery to data on the initial capacity retention ratio in the predetermined period and the last capacity retention ratio in the predetermined period; and
a unit configured to determine a linear sum model expression of a linear sum, a value of the aging degradation ratio, and a value of the current-carrying degradation ratio and configured to store the data in the tables, the linear sum being a sum of a value in which a product of each of the variables for use in recording the aging degradation ratio and each of the lengths of stay of the battery is added together at each of different SOCs and each of different temperatures and a value in which a product of each of the variables for use in recording the current-carrying degradation ratio and each of the current-carrying amounts in the battery is added together at each of different SOCs and each of different temperatures, the value of the aging degradation ratio and the value of the current-carrying degradation ratio being determined at each SOC and each temperature so as to reduce a difference between the degradation speed coefficients, wherein an arrangement of the aging degradation ratios and an arrangement of the current-carrying degradation ratios are usable in later prediction of the degradation of the battery.

10. The system according to claim 9, wherein the battery is a lithium-ion battery and the computational expression for calculating the degradation speed coefficient is based on a root law model.

11. The system according to claim 9, wherein the unit configured to determine the value of the aging degradation ratio and the value of the current-carrying degradation ratio at each SOC and each temperature is solved by a solver.

12. A battery degradation predicting system comprising:
a unit configured to read the data in the tables prepared in the system of claim 9;
a unit configured to read data on a future degradation environment;
a unit configured to calculate an amount of degradation of the capacity retention ratio by the linear sum model expression using the data in the tables and the data on the future degradation environment; and
a unit configured to determine a degradation predictive value by applying the calculated amount of degradation of the capacity retention ratio to the computational expression of the model.
